(19) United States
(12) Patent Application Publication
(10) Pub. No.: US 2026/0327448 A1
(43) Pub. Date: Oct. 22, 2026

(54) Ink Jet Ink Composition And Ink Jet Recording Method

(71) Applicant: SEIKO EPSON CORPORATION, Tokyo (JP)

(72) Inventors: Shun SUZUKI, Shiojiri (JP); Kentaro HARA, Shiojiri (JP)

(21) Appl. No.: 19/549,200

(22) Filed: Feb. 25, 2026

(30) Foreign Application Priority Data
Feb. 26, 2025 (JP) 2025-029474

(51) Int. Cl. C09D 11/38; B41J 2/21

(52) U.S. Cl. CPC C09D 11/38; B41J 2/2107

(57) ABSTRACT

An ink jet ink composition according to an embodiment of the present disclosure is an aqueous ink jet ink composition containing betaine and an organic solvent, in which the organic solvent includes an organic solvent A having a standard boiling point of 150 °C to 200 °C, having 4 to 7 carbon atoms, and having a branched carbon skeleton, which is a diol or a monohydric alcohol having one methoxy group.

The present application is based on, and claims priority from JP Application Serial Number 2025-029474, filed Feb. 26, 2025, the disclosure of which is hereby incorporated by reference herein in its entirety.

### BACKGROUND

### 1. Technical Field

The present disclosure relates to an ink jet ink composition and an ink jet recording method.

### 2. Related Art

The ink jet recording method can record high-definition images with a relatively simple apparatus, and is developing in various fields. Among these, there is consideration of recording an image on a recording medium having ink absorbency, such as high-quality paper, or a recording medium having low ink absorbency, such as coated paper, using an aqueous ink jet ink.

For example, JP-A-2021-133555 discloses an ink jet recording method of performing recording on a recording medium such as high-quality paper or coated paper using an aqueous ink composition.

However, there is a problem in achieving both excellent drying properties of the ink and suppression of the occurrence of curl (second curl) of the recording medium during the process of drying the ink attached to the recording medium.

### SUMMARY

An aspect of the ink jet ink composition according to the present disclosure is
an aqueous ink jet ink composition containing
betaine and an organic solvent, in which
the organic solvent includes an organic solvent A having a standard boiling point of 150 °C to 200 °C, having 4 to 7 carbon atoms, having a branched carbon skeleton, and being a diol or a monohydric alcohol having one methoxy group.

According to an aspect of the present disclosure, an ink jet recording method includes
an attaching step of ejecting the ink jet ink composition of the above-described aspect from an ink jet head to attach the ink jet ink composition to a recording medium.

### BRIEF DESCRIPTION OF THE DRAWINGS

FIG. 1 is a schematic view showing a side cross-sectional structure of an ink jet recording device used in the present embodiment.

FIG. 2 is Table 1 showing compositions and evaluation results of ink jet ink compositions according to examples.

FIG. 3 is Table 2 showing compositions and evaluation results of ink jet ink compositions according to examples.

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

In the present specification, a numerical range indicated by using “to” means a range including numerical values described before and after “to” as a lower limit value and an upper limit value. In the present specification, “(meth)acrylic” means acrylic or methacrylic, and “(meth)acrylate” means acrylate or methacrylate. In the present specification, the “ink jet ink composition” refers to an ink composition ejected from an ink jet head by an ink jet method and used for recording.

### 1. Ink jet ink Composition

An ink jet ink composition according to an embodiment of the present disclosure is an aqueous ink jet ink composition containing betaine and an organic solvent, in which the organic solvent includes an organic solvent A having a standard boiling point of 150 °C to 200 °C, having 4 to 7 carbon atoms, and having a branched carbon skeleton, which is a diol or a monohydric alcohol having one methoxy group.

In recording using an aqueous ink jet ink, in particular, in a case of using a low-absorbency recording medium, excellent drying property of the ink are required for fixing property of an ink coating film.

In addition, in a case of recording an image on an absorbency recording medium or a low-absorbency recording medium using an aqueous ink jet ink, curl (second curl) may occur in the recording medium during the process of drying the ink attached to the recording medium.

Here, it is considered that the second curl occurs because water absorbed in the recording medium penetrates between the cellulose molecules while cleaving hydrogen bonds, and as the water is removed during drying, hydrogen bonds are re-formed between the cellulose molecules at a distance shorter than the original. Then, in a case of rapid drying, the second curl is also deteriorated, whereby it is difficult to achieve both excellent drying properties of the ink and suppression of the second curl.

On the other hand, according to the ink jet ink composition according to the present embodiment, the ink jet ink composition contains betaine and a specific organic solvent, thereby achieving both excellent drying properties of the ink and suppression of the second curl.

It is considered that the specific organic solvent (organic solvent A) having a bulky molecular structure with a branch prevents the re-formation of hydrogen bonds between cellulose molecules, and it is presumed that the specific organic solvent contributes to the suppression of the second curl. Furthermore, it is presumed that the specific organic solvent having a molecular structure with a branch has a relatively high vapor pressure, and contributes to the excellent drying properties of the ink. It is considered that betaine has excellent moisture retention property and prevents the re-formation of hydrogen bonds between cellulose molecules, and it is presumed that the betaine contributes to the suppression of the second curl. Furthermore, betaine has excellent moisture retention property, but tends not to impair the drying property of the ink.

Hereinafter, each component contained in the ink jet ink composition according to the present embodiment will be described.

### 1.1 Betaine

The ink jet ink composition according to the present embodiment contains betaine. Betaine is a compound having a positive charge and a negative charge at non-adjacent positions in the same molecule, in which a hydrogen that can be dissociated is not bonded to an atom having a positive charge, and the compound constitutes an intramolecular salt and does not have a charge as a whole. It is considered that betaine has excellent moisture retention property and prevents the re-formation of hydrogen bonds between cellulose molecules, and it is presumed that the betaine contributes to the suppression of the occurrence of curl (second curl) of the recording medium during the process of drying the ink attached to the recording medium. In addition, betaine can also suppress the occurrence of curl (first curl) as a result of water in the ink attached to the recording medium penetrating between the cellulose molecules while cleaving hydrogen bonds and swelling.

It is preferable that the betaine is a compound having both an amino group and a carboxy group as functional groups. From the viewpoint of stability, the amino group is preferably a tertiary amino group or a quaternary amino group. Such a betaine is not particularly limited, and examples thereof include tertiary betaines such as dimethylglycine, dimethylalanine, dimethylglutamic acid, and diethylglycine; and quaternary betaines such as trimethylglycine, trimethylalanine, trimethylglutamic acid, and triethylglycine.

Among the tertiary betaines, dialkylglycines such as dimethylglycine and diethylglycine are preferable. In addition, among the quaternary betaines, trialkylglycines such as trimethylglycine or triethylglycine are preferable.

Among these, from the viewpoint of being able to achieve both excellent drying property and excellent moisture retention property, the betaine is preferably trialkylglycine. As the trialkylglycine, one or more selected from trimethylglycine or triethylglycine is preferable, and trimethylglycine is more preferable. It is noted that one type of the betaine may be used alone, or two or more types of the betaine may be used in combination. In particular, trialkylglycine in which all alkyl groups are alkyl groups having 3 or less carbon atoms is preferable, and trialkylglycine in which all alkyl groups are alkyl groups having 2 or less carbon atoms is more preferable.

In addition, it is preferable that the betaine is a solid at normal temperature and normal pressure. Examples of the betaine that is a solid at normal temperature and normal pressure include trimethylglycine and the like. The betaine that is a solid at normal temperature and normal pressure has excellent moisture retention property and does not particularly impair the drying property of the ink. Therefore, when the betaine that is a solid at normal temperature and normal pressure is used, the second curl and the first curl can be further suppressed, and the drying properties of the ink tend to be particularly excellent. In addition, the ejection stability (clogging recovery property) also tends to be further improved.

The betaine that is a solid at normal temperature and normal pressure tends to remain in the ink coating film even after recording. Therefore, in recording on a non-absorbency recording medium, since the ink is not absorbed into the recording medium, the betaine remains on the surface of the recording medium, and the betaine is redissolved in moisture or the like, whereby the ink tends to have poor moisture rubbing fastness. On the other hand, in recording on a low-absorbency recording medium such as coated paper, since the ink is slightly absorbed into the recording medium, the betaine remaining on the surface of the recording medium is reduced, and the moisture rubbing fastness tends to be improved.

The number of carbon atoms constituting the betaine is preferably 3 to 12, more preferably 3 to 7, and still more preferably 4 to 6. When the number of carbon atoms of the betaine is within the above-described range, the stability against disturbances such as contamination by electrostatically charged foreign substances may be further improved, and the storage stability of the ink may be further improved.

The lower limit of the content of the betaine is not particularly limited, but is preferably 0.1% by mass or more, more preferably 0.5% by mass or more, still more preferably 1.0% by mass or more, even still more preferably 2.0% by mass or more, particularly preferably 3.0% by mass or more, and more particularly preferably 5.0% by mass or more with respect to the total amount of the ink jet ink composition. When the content of the betaine is within the above-described range, the second curl and the first curl can be further suppressed, and the ejection stability tends to be further improved. The upper limit of the content of the betaine is not particularly limited, but is preferably 30% by mass or less, more preferably 20% by mass or less, still more preferably 15% by mass or less, even still more preferably 12% by mass or less, particularly preferably 10% by mass or less, and more particularly preferably 8% by mass or less with respect to the total amount of the ink jet ink composition. When the content of the betaine is within the above-described range, the drying property tends to be further improved.

In particular, the content of the betaine is preferably 0.5% to 10% by mass with respect to the total amount of the ink jet ink composition. When the content of the betaine is within the above-described range, the second curl and the first curl can be further suppressed, and the drying property tends to be further improved.

### 1.2 Organic Solvent

The ink jet ink composition according to the present embodiment contains an organic solvent. The organic solvent is preferably a water-soluble organic solvent. It is noted that the “water solubility” means that the solubility in water at 20 °C is more than 10 g/100 g of water.

Examples of the organic solvent include esters, glycol ethers, cyclic esters, amides, alcohols, polyhydric alcohols, and the like. In particular, glycol ethers, and polyhydric alcohols are preferable.

Examples of esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, methoxybutyl acetate; glycol diesters such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, dipropylene glycol acetate propionate, and the like.

Examples of the glycol ethers include monoether or diether of alkylene glycol. That is, the glycol ether is a monoether or a diether of glycol. As the ether of the monoether or diether, an alkyl ether is preferable. Examples of the monoether of alkylene glycol include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monobutyl ether, 3-methoxy-3-methylbutanol, and 3-methoxy-butanol. Examples of the diether of alkylene glycol include alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone; compounds in which a hydrogen of a methylene group adjacent to a carbonyl group thereof is substituted with an alkyl group having 1 to 4 carbon atoms, and the like.

Examples of the amides include cyclic amides, acyclic amides, and the like. Examples of the acyclic amides include alkoxyalkylamides and the like. Examples of the cyclic amides include lactams. Examples of the lactams include pyrrolidones such as 2-pyrrolidone, 1-methyl-2-pyrrolidone, 1-ethyl-2-pyrrolidone, 1-propyl-2-pyrrolidone, 1-butyl-2-pyrrolidone, and 1-(2-hydroxyethyl)pyrrolidin-2-one. Examples of alkoxyalkylamides include 3-methoxy-N, N-dimethylpropionamide, 3-methoxy-N, N-diethylpropionamide, 3-methoxy-N, N-methylethylpropionamide, 3-ethoxy-N, N-dimethylpropionamide, 3-ethoxy-N, N-diethylpropionamide, 3-ethoxy-N, N-methylethylpropionamide, 3-n-butoxy-N, N-dimethylpropionamide, 3-n-butoxy-N, N-diethylpropionamide, 3-n-butoxy-N, N-methylethylpropionamide, 3-n-propoxy-N, N-dimethylpropionamide, 3-n-propoxy-N, N-diethylpropionamide, 3-n-propoxy-N, N-methylethylpropionamide, 3-iso-propoxy-N, N-dimethylpropionamide, 3-iso-propoxy-N, N-diethylpropionamide, 3-iso-propoxy-N, N-methylethylpropionamide, 3-tert-butoxy-N, N-dimethylpropionamide, 3-tert-butoxy-N, N-diethylpropionamide, 3-tert-butoxy-N, N-methylethylpropionamide, N, N-dimethylisobutyrate amide, and the like.

Examples of the alcohols include a compound in which one hydrogen atom of a chain-like or cyclic hydrocarbon is substituted with a hydroxy group (hydroxyl group). Examples thereof include a compound in which one hydrogen atom of an alkane is substituted with a hydroxyl group. The number of carbon atoms of the alkane is preferably 10 or less, more preferably 6 or less, and still more preferably 3 or less. The number of carbon atoms of the alkane is 1 or more, and is preferably 2 or more. The alkane may be a linear type or a branched type. Examples of alcohols include methanol, ethanol, n-propyl alcohol, iso-propyl alcohol, n-butanol, 2—butanol, tert-butanol, iso-butanol, n-pentanol, 2—pentanol, 3—pentanol, tert-pentanol, 2—phenoxy ethanol, benzyl alcohol, phenoxy propanol, and the like.

The polyhydric alcohols are also referred to as polyols, and are also described as polyols. The polyols have two or more hydroxyl groups in a molecule. Examples of the polyols include diols, condensates of diols formed by intermolecular condensation between hydroxyl groups, polyhydric alcohols having a functionality of 3 or more, and the like. The polyols have a carbon hydrogen skeleton and two or more hydroxyl groups in a molecule, and may have an ether-bonded oxygen atom. Structures other than these structures are preferably not included.

Examples of diols include compounds in which two hydrogen atoms of an alkane are substituted with two hydroxyl groups. The compounds are also referred to as alkanediols, and are also described as alkanediols. Examples of alkanediols include 1,2-alkanediol, which is a general term for compounds in which hydroxyl groups are substituted at the first and second positions of alkanes, and other alkanediols other than 1,2-alkanediol. The number of carbon atoms in the alkanediols is preferably 2 or more, and more preferably 3 to 10. In addition, the number of carbon atoms in the alkanediols is preferably 5 or more, and more preferably 5 to 8. On the other hand, the number of carbon atoms in the alkanediols is also preferably 4 or less.

Examples of the 1,2-alkanediol include ethylene glycol, 1,2-propanediol (propylene glycol), 1,2-butanediol, 1,2-pentanediol (1,2PD), 1,2-hexanediol, 1,2-heptanediol, 1,2-octanediol, 1,2-nonanediol, 1,2-decanediol, 3-methyl-1,2-butanediol, 3-methyl-1,2-pentanediol, 4-methyl-1,2-pentanediol, 3,4-dimethyl-1,2-pentanediol, 3-ethyl-1,2-pentanediol, 4-ethyl-1,2-pentanediol, 3-methyl-1,2-hexanediol, 4-methyl-1,2-hexanediol, 5-methyl-1,2-hexanediol, 3,4-dimethyl-1,2-hexanediol, 3,5-dimethyl-1,2-hexanediol, 4,5-dimethyl-1,2-hexanediol, 3-ethyl-1,2-hexanediol, 4-ethyl-1,2-hexanediol, and 3-ethyl-4-methyl-1,2-hexanediol.

Examples of other alkanediols include 1,3-propanediol, 1,3-butylene glycol (also known as 1,3-butanediol), 1,4-butanediol, 2,3-butanediol, 1,5-pentanediol, 2,4-pentanediol, 2-methyl-1,3-propanediol, 3-methyl-1,3-butanediol, 3-methyl-1,5-pentanediol, 2-ethyl-1,3-hexanediol, 2-methyl-1,3-pentanediol, 3-methyl-1,5-pentanediol, 2-methylpentane-2,4-diol, 1,6-hexanediol, 2-ethyl-2-methyl-1,3-propanediol, 2-methyl-2-propyl-1,3-propanediol, and the like.

The condensates of diols formed by intermolecular condensation between hydroxyl groups include is condensates of two or more molecules of diols formed by intermolecular condensation between hydroxyl groups, and examples thereof include dialkylene glycols such as diethylene glycol and dipropylene glycol, and trialkylene glycols such as triethylene glycol and tripropylene glycol.

Examples of the polyhydric alcohols having a functionality of 3 or more include a compound having three or more hydroxyl groups, and the like. The compound having three or more hydroxyl groups is a compound having three or more hydroxyl groups with an alkane or a polyether structure as a skeleton. Examples of the compound having three or more hydroxyl groups include glycerol, trimethylolethane, trimethylolpropane, 1,2,5-hexanetriol, 1,2,6-hexanetriol, pentaerythritol, polyoxypropylenetriol, and the like.

The organic solvent may be used alone or in combination of two or more thereof.

The total content of the organic solvent is preferably 1% by mass or more, more preferably 3% by mass or more, still more preferably 5% by mass or more, and particularly preferably 10% by mass or more with respect to the total mass of the ink jet ink composition. In addition, from the viewpoint of further improving the drying property, the total content of the organic solvent is preferably 50% by mass or less, more preferably 40% by mass or less, still more preferably 30% by mass or less, particularly preferably 20% by mass or less, more particularly preferably 16% by mass or less, and still more particularly preferably 15% by mass or less with respect to the total mass of the ink jet ink composition.

### 1.2.1 Organic Solvent a

In the ink jet ink composition according to the present embodiment, the organic solvent includes an organic solvent A having a standard boiling point of 150 °C to 200 °C, 4 to 7 carbon atoms, and a branched carbon skeleton, which is a diol or a monohydric alcohol having a methoxy group.

The organic solvent A has a standard boiling point of 150 °C to 200 °C, 4 to 7 carbon atoms, a branched carbon skeleton, which is a diol or a monohydric alcohol having a methoxy group. It is considered that the organic solvent A is bulky because of a molecular structure with a branch, and prevents the re-formation of hydrogen bonds between cellulose molecules, and it is presumed that this contributes to the suppression of the second curl. Furthermore, it is presumed that the organic solvent A having a molecular structure with a branch has a relatively high vapor pressure, and contributes to the excellent drying properties of the ink.

In the present specification, the “branched carbon skeleton” means that a branched structure is present in a case of focusing on an arrangement of carbon atoms in a molecule (including a heteroatom between carbon atoms). For example, when the molecule has a methoxy group, a carbon atom in the methoxy group constitutes a part of the branched carbon skeleton. On the other hand, when the molecule has a hydroxyl group, since the hydroxyl group does not include a carbon atom, the hydroxyl group does not constitute a part of the branched carbon skeleton. Examples of the heteroatom that may be included between carbon atoms in the “branched carbon skeleton” include an oxygen atom, a nitrogen atom, a sulfur atom, and the like.

The organic solvent A has a standard boiling point of 150 °C to 200 °C, whereby the drying property of the ink can be excellent, and good moisture retention property can also be imparted. The standard boiling point of the organic solvent A is 150 °C to 200 °C, but is more preferably 155 °C to 200 °C and still more preferably 160 °C to 200 °C. Furthermore, the standard boiling point of the organic solvent A is preferably 165 °C to 190 °C and more preferably 170 °C to 180 °C

The organic solvent A has 4 to 7 carbon atoms, whereby the standard boiling point can be easily set to 150 °C to 200 °C, and both the drying property and the moisture retention property of the ink can be excellently achieved. The organic solvent A has 4 to 7 carbon atoms, but preferably has 5 to 7 carbon atoms and more preferably has 5or 6 carbon atoms.

The organic solvent A is a diol or a monohydric alcohol having one methoxy group. The diols are diols among the above-described polyhydric alcohols, and have two hydroxyl groups in a molecule. In addition, the monohydric alcohols have one hydroxyl group in a molecule. Since the methoxy group is a methyl ether group, the monohydric alcohols having one methoxy group are also a glycol monoether among the above-described glycol ethers. That is a glycol monomethyl ether. The diols preferably have a relatively low viscosity and excellent ejection stability.

Examples of the organic solvent A include hexylene glycol (2-methyl-2,4-pentanediol), 3-methoxy-3-methyl-1-butanol, 3-methoxy-1-butanol, and the like.

The content of the organic solvent A may be 0.5% to 20% by mass, and is preferably 1% to 15% by mass, more preferably 1% to 12% by mass, still more preferably 2% to 10% by mass, and particularly preferably 3% to 8% by mass with respect to the total amount of the ink jet ink composition. When the content of the organic solvent A is equal to or more than the lower limit, both the drying property and the moisture retention property tend to be improved, and the curl (first curl and second curl) tends to be suppressed. In addition, when the content of the organic solvent A is equal to or less than the upper limit, the ejection stability tends to be further improved.

### 1.2.2 Other Organic Solvents

Polyhydric alcohols or glycol ethers having a standard boiling point of 240 °C or higher

In the ink jet ink composition according to the present embodiment, from the viewpoint of further improving the moisture retention property, the organic solvent may further include an organic solvent having a standard boiling point of 240 °C or higher, which is polyhydric alcohols or glycol ethers.

From the viewpoint of further improving the moisture retention property, the organic solvent having a standard boiling point of 240 °C or higher, which is polyhydric alcohols or glycol ethers, is preferably polyhydric alcohols and more preferably polyhydric alcohols having a functionality of 3 or more. Examples thereof include glycerol. In addition, from the same viewpoint, the standard boiling point is preferably 250 °C or higher, more preferably 260 °C or higher, still more preferably 270 °C or higher, and particularly preferably higher than 280 °C. It is particularly still more preferably 290 °C or higher. The organic solvent having a standard boiling point of 240 °C or higher, which is polyhydric alcohols or glycol ethers, may have a branched carbon skeleton, but preferably does not have a branched carbon skeleton.

Examples of the organic solvent having a standard boiling point of 240 °C or higher, which is polyhydric alcohols or glycol ethers, include glycerol, diethylene glycol, triethylene glycol, tripropylene glycol, triethylene glycol monobutyl ether, and the like. Among these, at least one selected from glycerol or triethylene glycol is preferable.

From the viewpoint of being able to further achieve both excellent drying property and excellent moisture retention property, the content of the organic solvent having a standard boiling point of 240 °C or higher, which is polyhydric alcohols or glycol ethers, is preferably 9% by mass or less, more preferably 6% by mass or less, still more preferably 5% by mass or less, particularly preferably 4% by mass or less, more particularly preferably 3% by mass or less, and still more particularly preferably 2% by mass or less with respect to the total amount of the ink jet ink composition. The lower limit of the content of the organic solvent having a standard boiling point of 240 °C or higher, which is polyhydric alcohols or glycol ethers, is 0% by mass or more, that is, may not be contained, but from the viewpoint of further improving the moisture retention property, it is preferable to contain the organic solvent, and the content is preferably 0.1% by mass or more, more preferably 0.3% by mass or more, and particularly preferably 0.5% by mass or more. It is still more preferably 1% by mass or more. Alternatively, the content of the organic solvent having a standard boiling point of 260 °C or higher, which is polyhydric alcohols or glycol ethers, may be within the above-described range. Alternatively, the content of the organic solvent having a standard boiling point of higher than 280 °C, which is a polyhydric alcohol or a glycol ether, may be within the above-described range. These cases are also preferable from the above-described viewpoint. Polyhydric alcohols or glycol ethers having a standard boiling point of 200 °C or lower and not having a branched carbon skeleton

In the ink jet ink composition according to the present embodiment, the organic solvent may or may not include an organic solvent having a standard boiling point of 200 °C or lower, not having a branched carbon skeleton, which is polyhydric alcohols or glycol ethers, but from the viewpoint of suppressing the curl, it is preferably contained in an amount of a predetermined amount or less (not contained in an amount exceeding the predetermined amount). Since such an organic solvent has a low standard boiling point, the organic solvent is easily evaporated, and the speed of re-formation of hydrogen bonds between cellulose molecules is increased. In this case, it is presumed that the re-formation of hydrogen bonds between the cellulose molecules with a shorter bond distance than the original bond distance is promoted, and the curl is likely to occur.

From the above-described reason, the content of the organic solvent having a standard boiling point of 200 °C or lower and not having a branched carbon skeleton, which is polyhydric alcohols or glycol ethers, is preferably not more than 5% by mass, more preferably not more than 4% by mass, still more preferably not more than 3% by mass, particularly preferably not more than 1% by mass, and more particularly preferably not more than 0.5% by mass with respect to the total amount of the ink jet ink composition. The lower limit of the content is 0% by mass. That is, it is more preferable not to contain. Furthermore, it is still more preferable that the content of an organic solvent (for example, 1,3-butanediol or the like) having a standard boiling point of 210 °C or lower and not having a branched carbon skeleton, which is polyhydric alcohols or glycol ethers, is also within the above-described range.

Examples of the organic solvent having a standard boiling point of 200 °C or lower and not having a branched carbon skeleton, which is polyhydric alcohols or glycol ethers, include propylene glycol, 2-methoxyethanol, and the like.

Polyhydric alcohols or glycol ethers having a standard boiling point of higher than 200 °C and lower than 240 °C

In the ink jet ink composition according to the present embodiment, the organic solvent may include an organic solvent having a standard boiling point of higher than 200 °C and lower than 240 °C, which is polyhydric alcohols or glycol ethers. Such an organic solvent may function as a penetrant, and the image quality of the obtained image tends to be further improved. In addition, the organic solvent is excellent in terms of suppression of the curl as compared with the organic solvent having a standard boiling point of 200 °C or lower and not having a branched carbon skeleton, which is polyhydric alcohols or glycol ethers.

From the viewpoint of excellent suppression of the curl, the lower limit of the standard boiling point of the organic solvent having a standard boiling point of higher than 200 °C and lower than 240 °C, which is polyhydric alcohols or glycol ethers, is preferably 210 °C or higher, more preferably higher than 210 °C, and still more preferably 220 °C or higher. In addition, the upper limit of the standard boiling point is not particularly limited, but is preferably 230 °C or lower. The organic solvent having a standard boiling point of higher than 200 °C and lower than 240 °C, which is polyhydric alcohols or glycol ethers, may or may not have a branched carbon skeleton, but preferably does not have a branched carbon skeleton. The polyhydric alcohols are preferable, the diols are more preferable, and the 1,2-alkanediol is particularly preferable.

Examples of the organic solvent having a standard boiling point of higher than 200 °C and lower than 240 °C, which is polyhydric alcohols or glycol ethers, include 1,2-hexanediol, 1,3-butanediol, diethylene glycol monoethyl ether, and the like.

The content of the organic solvent having a standard boiling point of higher than 200 °C and lower than 240 °C, which is polyhydric alcohols or glycol ethers, is preferably 0.5% to 15% by mass, more preferably 1% to 10% by mass, still more preferably 2% to 8% by mass, and particularly preferably 3% to 7% by mass with respect to the total amount of the ink jet ink composition.

### 1.3 Water

The ink jet ink composition according to the present embodiment is an aqueous ink jet ink composition, and contains water. In the present specification, the “aqueous” means that at least water is contained as a solvent component, and water may be contained as a main solvent component.

Examples of the water include pure water such as ion-exchanged water, ultrafiltered water, reverse osmosis water, and distilled water, and water having reduced ionic impurities, such as ultrapure water. In addition, when water sterilized by irradiation with ultraviolet rays or addition of hydrogen peroxide or the like is used, the generation of bacteria and fungi can be suppressed when the ink jet ink composition is stored for a long period of time.

The water content is preferably 30% by mass or more, and more preferably 30% to 99% by mass in the liquid medium component. Furthermore, the water content is preferably 30% to 95% by mass, more preferably 40% to 90% by mass, and even more preferably 50% to 80% by mass. It is noted that the liquid medium is a solvent component such as water and an organic solvent.

In addition, a content of the water is preferably 40% by mass or more, further preferably 45% by mass or more, more preferably 50% by mass or more, and particularly preferably 60% by mass or more with respect to the total mass of the ink jet ink composition. An upper limit of the content of water is not particularly limited, but for example, is 99% by mass or less, preferably 90% by mass or less, more preferably 85% by mass or less, and still more preferably 80% by mass or less with respect to the total mass of the ink jet ink composition.

### 1.4 Surfactant

The ink jet ink composition according to the present embodiment may contain a surfactant. The surfactant can be used to reduce surface tension of the ink jet ink composition, for example, to adjust and improve permeability of the recording medium. As the surfactant, any of a nonionic surfactant, an anionic surfactant, a cationic surfactant, and an amphoteric surfactant can be used. In addition, among the surfactants, acetylene glycol-based surfactants, silicone-based surfactants, and fluorine-based surfactants can be more preferably used.

The acetylene glycol-based surfactant is not particularly limited and is, for example, preferably one or more selected from an alkylene oxide adduct of 2,4,7,9-tetramethyl-5-decyne-4,7-diol and 2,4,7,9-tetramethyl-5-decyne-4,7-diol, and an alkylene oxide adduct of 2,4-dimethyl-5-decyne-4-ol and 2,4-dimethyl-5-decyne-4-ol. A commercially available product of the acetylene glycol-based surfactant is not particularly limited. Examples thereof include SURFYNOL 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, DF110D (all product names, manufactured by Air Products Japan, K.K.), OLFINE B, Y, P, A, STG, SPC, E1004, E1010, PD-001, PD-002W, PD-003, PD-004, EXP. 4001, EXP. 4036, EXP. 4051, EXP. 4300,AF-103, AF-104, AK-02, SK-14, AE-3 (all product names, manufactured by Nissin Chemical Industry Co., Ltd.), and ACETYLENOL E00, E00P, E40, E100 (all product names, manufactured by Kawaken Fine Chemicals Co., Ltd.). One type of the acetylene glycol-based surfactant may be used alone, or two or more types of the acetylene glycol-based surfactant may be used in combination.

The silicone-based surfactant is not particularly limited. Examples thereof include a polysiloxane-based compound and polyether-modified organosiloxane. A commercially available product of the silicone-based surfactant is not particularly limited. Examples thereof include BYK-306, BYK-307, BYK-333, BYK-341, BYK-345, BYK-346, BYK-348, and BYK-349 (product names, manufactured by BYK Chemie Japan Co., Ltd.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (product names, manufactured by Shin-Etsu Chemical Co., Ltd.), and Silface SAG503A and Silface SAG014 (product names, manufactured by Nissin Chemical Industry Co., Ltd.). One type of the silicone-based surfactant may be used alone, or two or more types of the silicone-based surfactant may be used in combination.

The fluorine-based surfactant is not particularly limited. Examples thereof include perfluoroalkyl sulfonate, perfluoroalkyl carboxylate, perfluoroalkyl phosphate, a perfluoroalkyl ethylene oxide adduct, perfluoroalkyl betaine, and a perfluoroalkylamine oxide compound. A commercially available product of the fluorine-based surfactant is not particularly limited. Examples thereof include S-144 and S-145 (product names, manufactured by AGC Inc.); FC-170C, FC-430, Fluorad-FC4430 (product names, manufactured by Sumitomo 3M Co., Ltd.); FSO, FSO-100, FSN, FSN-100, and FS-300 (product names, manufactured by Dupont); and FT-250 and 251 (product names, manufactured by Neos Co., Ltd.). One type of the fluorine-based surfactant may be used alone, or two or more types of the fluorine-based surfactant may be used in combination.

The surfactant may be used alone or may be used in combination of two or more types thereof.

The ink jet ink composition according to the present embodiment preferably contains an acetylene glycol-based surfactant. When the acetylene glycol-based surfactant is used, the wetting spread and the permeability are further improved, and the image quality tends to be improved. In particular, when a low-absorbency recording medium such as coated paper or an absorbency recording medium such as general-purpose paper, the wetting spread and the permeability tend to be further improved. In addition, since the acetylene glycol-based surfactant is less likely to foam as compared with a silicone-based surfactant or the like, the ejection stability can be further improved.

The HLB value of the surfactant is not particularly limited. In the present specification, the “value of hydrophile and lipophile balance (HLB value)” is a numerical indicating a hydrophile and lipophile balance of the compound. Here, the HLB value is a value calculated by a Griffin method and can be determined by the following equation (H).

HLB Value=20×Total sum of formula weight of hydrophilic part/Molecular weight . . . (H)

For example, when an acetylene glycol-based surfactant having an HLB value of 5 or less is contained, the permeability of an absorbency recording medium such as general-purpose paper can be further improved. In addition, when an acetylene glycol-based surfactant having an HLB value of 5 or less is contained, the wetting spread on a low-absorbency recording medium such as coated paper can be further improved. Furthermore, the ink jet ink has a fine particle size, is easily jetted, and tends to have excellent ejection stability. It is presumed that the lower the HLB value of the acetylene glycol-based surfactant is, the higher the hydrophobicity is, and the surface tension of the ink is reduced. On the other hand, the lower the HLB value of the acetylene glycol-based surfactant is, the lower the solubility in water is, and in a condition in which the ink is dried, the phase separation of the acetylene glycol-based surfactant is likely to occur, the ejection failure is likely to occur, and the ejection reliability tends to be reduced. Therefore, it is preferable that the content in the ink is equal to or less than predetermined value. On the other hand, when the HLB value of the acetylene glycol-based surfactant is high, the above-described effect is obtained to some extent, and the insoluble matter of the acetylene glycol-based surfactant is unlikely to be generated even in a condition in which the ink is dried, which is preferable. From this viewpoint, the ink jet ink composition according to the present embodiment preferably contains an acetylene glycol-based surfactant having an HLB value of 5 or less and an acetylene glycol-based surfactant having an HLB value of more than 5.

The lower limit of the HLB value of the surfactant is not particularly limited, but is preferably 0 or more, 1 or more, and 2 or more. Furthermore, the lower limit of the HLB value is preferably 6 or more, 10 or more, and 13 or more. By setting the lower limit of the HLB value at or above the above-described range, the compatibility with the ink component is further improved, the phase separation is less likely to occur, and the ejection reliability tends to be further improved. The upper limit of the HLB value of the surfactant is not particularly limited, but is preferably 15 or less, 12 or less, and 10 or less. Furthermore, the upper limit of the HLB value is preferably 8 or less and 6 or less. By setting the upper limit of the HLB value at or below the above-described range, the permeability and the ejection stability tend to be further improved.

The content of the surfactant is preferably 10% by mass or less, more preferably 8% by mass or less, still more preferably 5% by mass or less, and particularly preferably 3% by mass or less with respect to the total mass of the ink jet ink composition. When the content of the surfactant is within the above-described range, the ejection stability tends to be more excellent. The lower limit of the content of the surfactant is not particularly limited, but is preferably 0.1% by mass or more, more preferably 0.5% by mass or more, and still more preferably 1.0% by mass or more with respect to the total mass of the ink jet ink composition. The content of the acetylene glycol-based surfactant may be within the above-described range, which is preferable. The content of the acetylene glycol-based surfactant having an HLB value of 5 or less is preferably 0.05% to 1% by mass, more preferably 0.1% to 0.7% by mass, still more preferably 0.2% to 0.6% by mass, and particularly preferably 0.3% to 0.5% by mass with respect to the total mass of the ink jet ink composition. When the content is within the above-described range, the permeability, the ejection stability, the ejection reliability, and the like tend to be more excellent.

### 1.5 Binder Resin

The ink jet ink composition according to the present embodiment may contain a binder resin. The binder resin has a function which improves the adhesion of ink attached to the recording medium. The binder resin is preferably a water-soluble resin or an emulsion form (resin particles), but may be a powder property. The emulsion form (resin particles) is more preferable.

Examples of the binder resin include resin types such as a urethane resin, a polyester resin, an acrylic resin, an olefin resin, a fluorene resin, a rosin-modified resin, a terpene resin, an amide resin, an epoxy resin, and a vinyl chloride resin.

The urethane resin is a general term for resins having a urethane bond. A polyether-type urethane resin including an ether bond in a main chain, an ester-type urethane resin including an ester bond in a main chain, a carbonate-type urethane resin including a carbonate bond in a main chain, or the like other than the urethane bond may also be used as the urethane resin.

A commercially available product of the urethane resin may be used. Examples thereof include Superflex 460, 460s, 840, and E-4000 (product names, manufactured by DKS Co., Ltd.), Resamine D-1060, D-2020, D-4080, D-4200, D-6300, and D-6455 (product names, manufactured by Dainichiseika Color & Chemicals MFG Co., Ltd.), Takelac WS-5100, WS-6021, W-512-A-6, and W-6110 (product names, manufactured by Mitsui Chemicals Polyurethanes, Inc.), Sancure 2710 (product name, manufactured by LUBRIZOL), and Permarin UA-150 (product name, manufactured by Sanyo Chemical Industries Ltd.).

The polyester resin has a constitutional unit derived from a polyvalent carboxylic acid such as terephthalic acid, isophthalic acid, and orthophthalic acid, and a constitutional unit derived from a polyhydric alcohol such as ethylene glycol, 1,2-propylene glycol, and 1,3-propylene glycol, and is obtained by a known condensation reaction between the polyvalent carboxylic acid and the polyhydric alcohol.

A commercially available product may be used as the polyester resin. Examples of the commercially available product of the polyester resin include ELITEL (registered trademark) KA-5034, KA-5071S, KA-1449, KA-0134, KA-3556, KA-6137, KZA-6034, KT-8803, KT-8701, KT-9204, KT-8904, KT-0507, and KT-9511 (product names) manufactured by Unitika Ltd. ; PLASCOAT (registered trademark) Z-221, Z-446, Z-561, Z-565, RZ-570, Z-592, Z-687, Z-690, Z-730, Z-760, Z-880, RZ-105, RZ-570, and RZ-760 (product names) manufactured by Goo Chemical Co., Ltd. ; and VYLONAL (registered trademark) MD-1200, MD-1500, and MD-2000 (product names) manufactured by TOYOBO MC Corporation. These may be used alone or in combination of a plurality of types thereof.

The acryl resin is a general term for polymers obtained by polymerizing at least an acryl monomer such as (meth)acrylic acid and (meth)acrylate as one component. Examples of the acryl resin include a resin obtained from an acryl monomer, and a copolymer of an acryl monomer and a monomer other than the acryl monomer. Examples of the acryl resin also include an acrylic-vinyl resin that is a copolymer of an acryl monomer and a vinyl monomer. Examples of the vinyl monomer include styrene. As the acryl monomer, acrylamide, acrylonitrile, and the like can also be used.

A commercially available product of a resin emulsion using the acryl resin as a raw material may be used. For example, a product selected from FK-854 (product name, manufactured by CHUORIKA KOUGYO Co., Ltd.), Mowinyl 952B and 718A (product names, manufactured by The Nippon Synthetic Chemical Industry Co., Ltd.), and Nipol LX852 and LX874 (product names, manufactured by Zeon Corporation) may be used.

Incidentally, in the present specification, the acrylic resin may be a styrene-acrylic resin described below. In addition, in the present specification, the notation of “(meth)acrylic” means acrylic and methacrylic.

The styrene-acrylic resin is a copolymer obtained from a styrene monomer and a (meth)acrylic monomer, and examples thereof include a styrene-acrylic acid copolymer, a styrene-methacrylic acid copolymer, a styrene-methacrylic acid-acrylic ester copolymer, a styrene-α-methylstyrene-acrylic acid copolymer, and a styrene-α-methylstyrene-acrylic ester copolymer. A commercially available product of the styrene-acryl resin may be used. For example, Joncryl 62J, 7100, 390, 711, 511, 7001, 632, 741, 450, 840, 74J, HRC-1645J, 734, 852, 7600, 775, 537J, 1535, PDX- 7630A, 352J, 352D, PDX- 7145, 538J, 7640, 7641, 631, 790, 780, and 7610 (product names, manufactured by BASF), Mowinyl 966A and 975N (product names, manufactured by The Nippon Synthetic Chemical Industry Co., Ltd.), and VINYBLAN 2586 (manufactured by Nissin Chemical Industry Co., Ltd.) may be used.

The olefin resin is a polymer having olefin such as ethylene, propylene, and butylene in a structural skeleton. Well-known olefin resins can be appropriately selected for use. As the olefin resin, a commercially available product can be used. For example, ARROWBASE CB-1200 and CD-1200 (trade names, manufactured by Unitika Ltd.), or the like may be used.

The fluorene resin is a general term for a resin having a fluorene skeleton. Examples of the fluorene resin include a fluorene-based polyester resin, a fluorene-based polyurethane resin, a fluorene-based polyimide resin, a fluorene-based polycarbonate resin, a fluorene-based acrylic resin, a fluorene-based epoxy resin, and the like.

The rosin-modified resin is a general term for a resin derived from rosin. Examples of the rosin-modified resin include a rosin-modified phenol resin, a maleic acid-modified rosin resin, a rosin ester, and the like.

The terpene resin refers to a resin obtained by cationically polymerizing a monomer containing, for example, α-pinene, β-pinene, dipentene, and the like as main components, using isoprene (C₅H₈) as a basic unit.

The amide resin is a resin in which a main chain is formed by repeating an amide bond. The amide resin is not particularly limited, and examples thereof include nylon 6,nylon 11, nylon 12, nylon 66, nylon 610, nylon 6T, nylon 6I, nylon 6T, nylon M5T, nylon 612, and the like.

The epoxy resin refers to a resin having a reactive epoxy group, and examples thereof include bisphenol-type epoxy such as a bisphenol A type and a bisphenol F type, novolac-type epoxy such as a phenol novolac type and a cresol novolac type, epoxy polyol-type epoxy, urethane-modified epoxy, chelate-modified epoxy, rubber-modified epoxy, and the like.

The vinyl chloride resin is not particularly limited, and examples thereof include copolymer resins of vinyl chloride and one or two or more selected from the group consisting of vinyl acetate, vinylidene chloride, acryl, maleic acid, and vinyl alcohol.

The binder resin may be used alone or in combination of two or more types thereof.

The glass transition temperature (Tg) of the binder resin is preferably- 50 °C or higher and 200 °C or lower, more preferably 0 °C or higher and 150 °C or lower, and even more preferably 50 °C or higher and 100 °C or lower. In addition, the glass transition temperature is particularly preferably 50 °C or higher and 80 °C or lower. The glass transition temperature (Tg) of the binder resin being within the range described above tends to make the durability and clogging resistance superior. For example, the glass transition temperature is measured in accordance with JIS K 7121 (Measurement Methods for Transition Temperatures of Plastics) using a differential scanning calorimeter “DSC 7000” manufactured by Hitachi High-Tech Science Corporation.

The volume average particle diameter of the binder resin is preferably 10 nm or more and 300 nm or less, more preferably 30 nm or more and 300 nm or less, even more preferably 30 nm or more and 250 nm or less, and particularly preferably 40 nm or more and 220 nm or less. The volume average particle diameter can be measured by the method which will be described later.

The acid value of the resin of the binder resin is preferably 50 mg KOH/g or less, more preferably 30 mg KOH/g or less, still more preferably 20 mg KOH/g or less, and even still more preferably 10 mg KOH/g or less. In addition, the lower limit of the acid value is 0 mg KOH/g or more, preferably 5 mg KOH/g or more, and more preferably 10 mg KOH/g or more. This case is preferable since the image quality and the like are excellent. The acid value can be measured by the method which will be described later.

The content of the binder resin when the binder resin is contained is, as solid content, 0.1% by mass or more and 20% by mass or less, preferably 0.1% by mass or more and 15% by mass or less, more preferably 0.5% by mass or more and 10% by mass or less, and still more preferably 1% by mass or more and 5% by mass or less with respect to a total amount of the ink jet ink composition.

### 1.6 Coloring Material

The ink jet ink composition according to the present embodiment may contain a coloring material. When the coloring material is contained, in particular, in a case of an ink having high drying property, the nozzle of the ink jet head is likely to be clogged. On the other hand, since the ink jet ink composition according to the present embodiment can achieve both excellent drying property and moisture retention property, even when the color material is contained, good ejection stability can be obtained.

Examples of the coloring material include pigments, dyes, and the like. The coloring material can be a coloring material such as cyan, yellow, magenta, and black, or a white coloring material. In addition, the color material may be a color material used for a spot color ink such as red, orange, blue, and green, or a light ink such as light magenta, light cyan, and gray.

The lower limit of the content of the coloring material is not particularly limited, but is preferably 0.5% by mass or more, more preferably 1.0% by mass or more, still more preferably 2.0% by mass or more, even still more preferably 3.0% by mass or more, and particularly preferably 4.0% by mass or more with respect to the total amount of the ink jet ink composition. When the content of the coloring material is within the above-described range, the color-developing property tends to be more excellent, but the nozzle of the ink jet head is likely to be clogged. On the other hand, since the ink jet ink composition according to the present embodiment can achieve both excellent drying property and moisture retention property, even when the content of the coloring material is within the above-described range, good ejection stability can be obtained.

The upper limit of the content of the coloring material is not particularly limited, but is preferably 20% by mass or less, more preferably 15% by mass or less, still more preferably 12% by mass or less, even still more preferably 10% by mass or less, particularly preferably 8% by mass or less, and more particularly preferably 7% by mass or less with respect to the total amount of the ink jet ink composition. When the content of the coloring material is within the above range, the ejection stability tends to be excellent.

### 1.6.1 Pigment

When a pigment is used as the coloring material, the weather resistance of the ink jet ink composition may be improved. Examples of the pigment include an inorganic pigment and an organic pigment.

As the inorganic pigment, carbon blacks such as C.I. Pigment Black 6 (lamp black, vegetable black), C.I. Pigment Black 7 (furnace black, channel black, thermal black, acetylene black), C.I. Pigment Black 8 (charcoal black), and C.I. Pigment Black 10 (graphite), iron oxide, titanium oxide, zinc oxide, and silica can be used.

Examples of the carbon black include No. 2300, 900, MCF 88, No. 20B, No. 33, No. 40, No. 45, No. 52, MA 7, MA8, MA100, and No2200B manufactured by Mitsubishi Chemical Corporation. Examples of the carbon black also include color black FW1, FW2, FW2V, FW18, FW200, S150, S160, and S170, Pretex 35, U, V, and 140U, and special black 6, 5, 4A, 4, and 250 manufactured by Degussa Corporation. Examples of the carbon black also include Conductex SC and Raven 1255, 5750,5250, 5000, 3500, 1255, and 700 manufactured by Columbia Carbon Company. Examples of the carbon black also include Regal 400R, 330R, and 660R, Mogul L, Monarch 700, 800, 880,900, 1000, 1100, 1300, and 1400, and Elftex 12 manufactured by Cabot Corporation.

Examples of the organic pigment include a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, and an azo-based pigment.

Specific examples of organic pigments include the following.

Examples of a cyan pigment include C.I. Pigment Blue 1, 2, 3, 15:3, 15:4, 15:34, 16, 22, and 60; and C.I. Vat Blue 4 and 60, and one or a mixture of two or more selected from a group consisting of C.I. Pigment Blue 15:3, 15:4, and 60 is preferably used.

Examples of a magenta pigment include C.I. Pigment Red 5, 7, 12, 48, 48, 57, 57:1, 112, 122, 123, 168, 184, and 202 and C.I. Pigment Violet 19, and one or a mixture of two or more selected from a group consisting of C.I. Pigment Red 122, 202, and 209 and C.I. Pigment Violet 19 is preferably used. A solid solution of the pigment is also favorable.

Examples of the yellow pigment include C.I. Pigment Yellow 1, 2, 3, 12, 13, 14C, 16, 17, 73, 74, 75, 83,93, 95, 97, 98, 119, 110, 114, 128, 129, 138, 150, 151, 154, 155, 180, 185, and the like, and preferably include a mixture of one or two or more selected from the group consisting of C.I. Pigment Yellow 74, 109, 110, 128, 138, 155, and 180.

Examples of the orange pigment include C.I. Pigment Orange 36 or 43 or a mixture thereof. Examples of the green pigment include C.I. Pigment Green 7 or 36 or a mixture thereof.

In addition, a bright pigment may be used, the pigment is not particularly limited as long as the pigment is able to exhibit brightness when attached to a medium, and examples thereof include metal particles of one or two or more alloys (also referred to as metal pigment) selected from the group consisting of aluminum, silver, gold, platinum, nickel, chromium, tin, zinc, indium, titanium, and copper, a pearl pigment having pearl gloss, and the like. Representative examples of the pearl pigment include a pigment having pearl gloss or interference gloss such as titanium dioxide-coated mica, fish scale foil, and bismuth oxychloride. In addition, the bright pigment may be subjected to a surface treatment for suppressing a reaction with water.

In addition, a white pigment may be used, and examples of the white pigment include metal compounds such as metal oxide, barium sulfate, and calcium carbonate. Examples of the metal oxide include titanium dioxide, zinc oxide, silica, alumina, magnesium oxide, and the like. In addition, particles having a hollow structure may be used for the white pigment.

The above-mentioned pigments may be used alone or in combination of two or more thereof. The pigment is preferably an organic pigment from the viewpoint of storage stability such as light resistance, weather resistance, and gas resistance.

When a pigment is adopted for the coloring material, the volume average particle diameter (D50) of the pigment particles is preferably 10 nm or more and 300 nm or less, more preferably 30 nm or more and 250 nm or less, even more preferably 50 nm or more and 250 nm or less, and particularly preferably 70 nm or more and 200 nm or less. Furthermore, the volume average particle diameter is preferably 80 nm or more and 150 nm or less. When the volume average particle diameter is within the above range, this case is preferable from a viewpoint that a desired coloring material is easily obtained or characteristics of the coloring material and the like are easily improved. The measurement of the volume average particle diameter may be performed by using, for example, a Nanotrac series particle diameter distribution measurement device manufactured by MicrotracBEL Corp. In addition, examples of a method of adjusting the volume average particle diameter include a method of adjusting a volume average particle diameter by adjusting a degree of pulverization of a pigment before dispersion, a method of adjusting a volume average particle diameter by adjusting stirring conditions (for example, stirring speed, stirring temperature, and the like) during dispersion, a method of adjusting a volume average particle diameter by filtration using a filter after dispersion, and the like.

### 1.6.2 Dye

As dyes, for example, various dyes normally used for ink jet ink composition such as direct dyes, acidic dyes, edible dyes, basic dyes, reactive dyes, dispersion dyes, construction dyes, soluble construction dyes, reaction dispersion dyes, and the like can be used.

The dye is not particularly limited, but examples thereof include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50,55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

The coloring material may be either a pigment or a dye, or may be a mixture. However, among pigments and dyes, it is more preferable to include pigments. The pigment is excellent in storage stability such as light resistance, weather resistance, and gas resistance, and is preferably an organic pigment from that viewpoint.

### 1.6.3 Dispersant

It is preferable that the coloring material can be stably dispersed in the dispersion medium, and therefore, a dispersant may be used to disperse the white coloring material. As the dispersant, there is provided a resin dispersant and the like, and the dispersant is selected from those that can improve dispersion stability of the coloring material in the ink composition. In addition, the coloring material may be used as a self-dispersion type pigment by modifying a surface of a pigment particle by oxidizing or sulfonating the surface of the pigment with, for example, ozone, hypochlorous acid, fuming sulfuric acid, or the like.

Examples of the resin dispersant (dispersant resin) include (meth)acrylic resins such as poly(meth)acrylic acid, (meth)acrylic acid-acrylonitrile copolymers, (meth)acrylic acid-(meth)acrylic acid ester copolymers, vinyl acetate-(meth)acrylic acid ester copolymers, vinyl acetate-(meth)acrylic acid copolymers, and vinyl naphthalene-(meth)acrylic acid copolymers, and salts thereof, styrene-based resins such as styrene-(meth)acrylic acid copolymers, styrene-(meth)acrylic acid-(meth)acrylic acid ester copolymers, styrene-α-methylstyrene-(meth)acrylic acid copolymers, styrene-α-methylstyrene-(meth)acrylic acid-(meth)acrylic acid ester copolymers, styrene-maleic acid copolymers, and styrene-maleic acid anhydride copolymers, and salts thereof, urethane-based resins, which are polymer compounds (resins) having a urethane bond formed when an isocyanate group reacts with a hydroxyl group, and which may be linear and/or branched regardless of a crosslinked structure, and salts thereof, polyvinyl alcohols, vinyl naphthalene-maleic acid copolymers and salts thereof, vinyl acetate-maleic acid ester copolymers and salts thereof, and water-soluble resins such as vinyl acetate-crotonic acid copolymers and salts thereof. Among these, a copolymer of a monomer having a hydrophobic functional group and a monomer having a hydrophilic functional group, and a polymer formed of monomers having both a hydrophobic functional group and a hydrophilic functional group are preferable. As the form of the copolymer, any form of a random copolymer, a block copolymer, an alternating copolymer, and a graft copolymer can be used. Among the styrene-based resins, a copolymer with a (meth)acrylic monomer is also a (meth)acrylic resin.

Examples of commercially available products of the styrene-based resin dispersant include X-200, X-1, X-205, X-220, and X-228 (manufactured by SEIKO PMC CORPORATION), NOPCOSPERSE (registered trademark) 6100 and 6110 (manufactured by SAN NOPCO LIMITED), Joncryl 67, 586, 611, 678, 680, 682, and 819 (manufactured by BASF SE), DISPER BYK-190 (manufactured by BYK Japan KK.), and N-EA137, N-EA157, N-EA167, N-EA177, N-EA197D, N-EA207D, and E-EN10 (manufactured by DKS Co., Ltd.).

In addition, examples of commercially available products of the acrylic resin dispersants include BYK-187, BYK-190, BYK-191, BYK-194N, and BYK-199 (manufactured by BYK Japan KK.), and Aron A-210, A6114, AS-1100, AS-1800, A-30SL, A-7250, and CL-2 (manufactured by TOAGOSEI CO., LTD.).

Furthermore, examples of commercially available products of the urethane-based resin dispersant include BYK-182, BYK-183, BYK-184, and BYK-185 (manufactured by BYK Japan KK.), TEGO Dispers 710 (manufactured by Evonik Tego Chemi GmbH), and Borchi (registered trademark) Gen 1350(manufactured by OMG Borchers GmbH).

These dispersants may be used alone or in combination of two or more thereof.

Among the dispersants exemplified above, it is more preferable that the dispersant is at least one selected from anionic dispersant resins. In addition, in this case, it is more preferable that a weight average molecular weight of the dispersant is 500 or more. Furthermore, the weight average molecular weight is preferably 5,000 or more and 100,000 or less, and more preferably 10,000 or more and 50,000 or less.

By using such a resin dispersant as the dispersant, the dispersion and cohesion of the coloring material are further improved, and an image having more favorable dispersion stability and more favorable image quality can be obtained.

The anionic dispersant resin is a resin in which the resin has an anionic functional group and exhibits anionic properties. Examples of the anionic functional group include a carboxyl group, a sulfo group, and a phosphoric acid group. Among these groups, a carboxyl group is more preferable.

The dispersant resin preferably has an acid value, and the acid value is preferably 5 mg KOH/g or more, more preferably 10 to 200 mg KOH/g, and even more preferably 15 to 150 mg KOH/g. Furthermore, an acid value of 20 to 100 mg KOH/g is preferable, and an acid value of 30 to 80 mg KOH/g is more preferable. Furthermore, the lower limit thereof is preferably 40 mg KOH/g or more, more preferably 50 mg KOH/g or more, still more preferably 60 mg KOH/g or less, and even still more preferably 70 mg KOH/g or less. It is noted that the acid value can be measured by the neutralization titration method in accordance with JIS K 0070. As a titration device, for example, “AT610” manufactured by Kyoto Electronics Manufacturing Co., Ltd. can be used.

The total content of the dispersant is preferably 0.1 parts by mass or more and 30 parts by mass or less, more preferably 0.5 parts by mass or more and 25 parts by mass or less, still more preferably 1 part by mass or more and 20 parts by mass or less, further preferably 1.5 parts by mass or more and 15 parts by mass or less, with respect to 50 parts by mass of the coloring material. When the content of the dispersant is 0.1 parts by mass or more with respect to 50 parts by mass of the coloring material, the dispersion stability of the coloring material can be further improved. In addition, when the content of the dispersant is 30 parts by mass or less with respect to 50 parts by mass of the coloring material, the viscosity of the obtained dispersion can be suppressed to be small.

### 1.7 Other Components

The ink jet ink composition according to the present embodiment may include an additive such as preservative and fungicide, pH adjuster, rust inhibitor, chelating agent, viscosity modifier, dissolution aid, and antioxidant, depending on the necessity. A content of such an additive when contained is not particularly limited, but is preferably 0.1% to 5% by mass, more preferably 0.1% to 3% by mass, and further preferably 0.1% to 1% by mass with respect to the total amount of the ink jet ink composition.

### 1.8 Application

The recording medium to which the ink jet ink composition according to the present embodiment is applied is not particularly limited, and may be an absorbency recording medium, a low-absorbency recording medium, or a non-absorbency recording medium.

The term low-absorbency recording medium or non-absorbency recording medium refers to a recording medium having a property of not absorbing liquid at all or absorbing little liquid. Quantitatively, the low-absorbency recording medium or non-absorbency recording medium refers to “a recording medium in which a water absorption amount from the start of contact to 30 msec^{1/2} in the Bristow method is 10 mL/m² or less”. The Bristow method is the most popular method as a method of measuring a liquid absorption amount in a short time, and is also adopted by the Japan Technical Association of the Pulp and Paper Industry (JAPAN TAPPI). Details of a test method are described in “Paper and Paperboard-Liquid-Absorbency Test Method-Bristow Method” of Standard No. 51 of “JAPAN TAPPI Paper and Pulp Test Method 2000 Edition”. On the other hand, the absorbency recording medium refers to a recording medium that does not correspond to a low-absorbency recording medium or a non-absorbency recording medium.

Examples of the low-absorbency recording medium include a recording medium in which a coating layer having low absorbency is provided on a surface thereof, and the low-absorbency recording medium is referred to as a coated paper. Examples of the recording medium whose base material is paper include printed paper such as art paper, coated paper, and matte paper. When the base material is a plastic film, examples thereof include recording media in which a polymer or the like is coated onto a surface such as polyvinyl chloride, polyethylene terephthalate, polycarbonate, polystyrene, polyurethane, polyethylene, and polypropylene, and recording media in which particles such as silica, titanium, and the like are coated with a binder.

Examples of the non-absorbency recording medium include a medium in which plastic is coated on a base material such as paper, a medium in which a plastic film adheres to the base material such as paper, and a plastic film without an absorbing layer (receiving layer). Examples of the plastic include polyvinyl chloride, polyethylene terephthalate, polycarbonate, polystyrene, polyurethane, polyethylene, polypropylene, and the like.

From the viewpoint of more fully realizing the advantages afforded by the present disclosure, the ink jet ink composition according to the present embodiment is preferably used for recording on a low-absorbency recording medium having paper as a substrate. In a case of recording an image on a low-absorbency recording medium having paper as a substrate using an aqueous ink jet ink, the curl (second curl) may occur in the recording medium during the process of drying the ink attached to the recording medium. In addition, in a case of using the low-absorbency recording medium, the ink is required to have particularly excellent drying property for fixing property of the ink coating film. Therefore, in a case of being used for recording on a low-absorbency recording medium having paper as a substrate, the ink is required to have more excellent drying property and to suppress the second curl. On the other hand, even in a case of being used for recording on a low-absorbency recording medium having paper as a substrate, the ink jet ink composition according to the present embodiment can achieve both excellent drying property of the ink and suppression of the second curl.

Furthermore, when the low-absorbency recording medium having paper as a substrate is cut-sheet paper, the curl significantly occurs. In a case of being a roll paper, since the recording medium is fixed by a roller, both the first curl and the second curl are unlikely to occur. On the other hand, in a case of being cut-sheet paper, the first curl immediately occurs when the ink adheres to the recording medium. In addition, since the recording medium is dried in a state of being not fixed, the second curl also occurs. As described above, when the low-absorbency recording medium having paper as a substrate is cut-sheet paper, the ink is required to have excellent drying property and to suppress the curl more excellently. On the other hand, even when the low-absorbency recording medium having paper as a substrate is cut-sheet paper, the ink jet ink composition according to the present embodiment can achieve both excellent drying property of the ink and more excellent suppression of the curl. It is noted that the cut-sheet paper refers to a recording medium cut into a standard size such as A4.

### 2. Ink jet Recording Method

The ink jet recording method according to an embodiment of the present disclosure includes an attaching step of ejecting the ink jet ink composition described above from an ink jet head to attach the ink jet ink composition to a recording medium.

The ink jet recording method according to the present embodiment can make the fixing property of the ink coating film of the recorded material excellent by using the above-described ink jet ink composition having excellent drying property of the ink. Therefore, according to the ink jet recording method according to the present embodiment, both the excellent fixing property of the ink coating film of the recorded material and the suppression of the second curl can be obtained.

Hereinafter, each step of the ink jet recording method according to the present embodiment will be described.

### 2.1 Attaching Step

The ink jet recording method according to the present embodiment includes an attaching step of ejecting the ink jet ink composition described above from an ink jet head to attach the ink jet ink composition to a recording medium.

Since the recording medium is as described above, a description thereof will not be repeated.

The amount of the ink jet ink composition attached to a region of the recording medium to which the ink is attached in the attaching step is preferably 15 mg/inch² or less, more preferably 12 mg/inch² or less, and still more preferably 10 mg/inch² or less per unit area of the recording medium.

In the attaching step, it is preferable that a surface temperature of the recording medium when the above-described ink jet ink composition is attached to the recording medium is 55 °C or lower. In this case, the attaching step may be performed without heating the recording medium, or may be performed by heating the recording medium. That is, even when heating, it is preferable to heat the recording medium such that the surface temperature of the recording medium is 55 °C or lower.

The upper limit value of the surface temperature of the recording medium at the time the ink is attached is preferably 55 °C or lower, more preferably 50 °C or lower, still more preferably 45 °C or lower, particularly preferably 40 °C or lower, more particularly preferably 35 °C or lower, and still more particularly preferably 28 °C or lower. On the other hand, the lower limit value is preferably 20 °C or higher, more preferably 23 °C or higher, and particularly preferably 25 °C or higher. Furthermore, the lower limit value is preferably 28 °C or higher, more preferably 35 °C or higher, and still more preferably 40 °C or higher.

### 2.2 Primary Drying Step

The ink jet recording method according to the present embodiment may include a primary drying step of drying the ink jet ink composition attached to the recording medium. On the other hand, in the ink jet recording method according to the present embodiment, by using the above-described ink jet ink composition having excellent drying property of the ink, the ink is sufficiently dried even without including the primary drying step, and a recorded material having excellent ink fixing property tends to be obtained.

The primary drying step is a step of drying the ink attached to the recording medium at an early stage. The primary drying step is a step for drying at least a part of a solvent component in the ink to an extent that the ink attached to the recording medium is at least reduced in the flow of the ink. In the primary drying step, it is preferable that the ink droplet that has landed on the recording medium starts to dry within 0.5 seconds at the latest from the landing of the ink droplet.

Examples of methods for the primary drying step include a blower type, which is a method based on normal temperature air blowing (normal temperature air) or air blowing (warm air) associated with heating, to the recording medium by a fan and the like, a radiation type of IR heater and microwave, a heat transfer type based on heating the recording medium in contact with a heated member such as a platen heater, a method combining the above types, or the like.

In the primary drying step, when drying is performed by blowing air, the wind speed of the blowing air is preferably 0.5 to 15 m/s, more preferably 0.5 to 10 m/s, still more preferably 1 to 5 m/s, and particularly preferably 2 to 3 m/s. The wind speed is a wind speed near the surface of the recording medium. An air temperature in the air blowing is preferably 55 °C or lower, and more preferably 10 °C or higher. Furthermore, the air temperature in the air blowing is preferably 15 °C to 50 °C, and is more preferably 20 °C to 49 °C. In addition, the air temperature in the air blowing is preferably 23 °C to 40 °C, more preferably 25 °C to 35 °C, and still more preferably 25 °C to 28 °C. The air temperature in the air blowing may be a normal temperature.

In addition, the surface temperature of the recording medium in the primary drying step may be in the range of the temperature described as the surface temperature of the recording medium in the above-described attaching step, which is preferable. That is, the surface temperature of the recording medium in the primary drying step is particularly preferably 55 °C or lower, and more preferably the above-described surface temperature range. When the drying temperature by the primary drying step is within the above-described range, the drying of the ink in the ink jet head can be reduced, whereby the clogging recovery property tends to be more excellent.

It is noted that when the primary drying step is performed with heating, in the primary drying step, the ink may be attached to the heated recording medium, or the recording medium may be heated early after the ink is attached. In the primary drying step, it is preferable that the ink droplet that has landed on the recording medium starts to heat within 0.5 seconds at the latest from the landing of the ink droplet. When the primary drying step is performed with heating, the heating may be performed before the above-described attaching step, at the same time as the attaching, or early after the attaching, and is preferably performed at the same time. The attaching step can be performed in such a heating order.

It is noted that the surface temperature of the recording medium in the primary drying step is the surface temperature of the recording medium at the time of ink attaching when the ink is attached to the recording medium the has undergone the primary drying step, and the surface temperature of the recording medium at the time the primary drying step is performed when the primary drying step is performed shortly after the ink is attached. In addition, the surface temperature of the recording medium in the primary drying step is the maximum temperature by the primary drying step. The surface temperature of the recording medium in the primary drying step at that time is preferably in the range of the surface temperature of the recording medium at the time the ink is attached, described above. In addition, the surface temperature of the recording medium without heating in the primary drying step is the surface temperature of the recording medium at the time the ink is attached.

### 2.3 Post-Heating Step

The ink jet recording method according to the present embodiment may include a post-heating step of heating the recording medium after the above-described attaching step.

The post-heating step is a heating step in which the recording is completed and the recorded material is sufficiently heated to the extent that the recorded material can be used. The post-heating step is a heating step for sufficiently drying a solvent component of the ink and heating the binder resin and the like that can be contained in the ink to flatten the ink coating film. The post-heating step is preferably started more than 0.5 seconds after the attaching of the ink to the recording medium. For example, it is preferable to start heating the region more than 0.5 seconds after the attaching of ink to a recording region on the recording medium is completed. In addition, the temperature preferable in the primary drying step is preferably different from the temperature preferable in the post-heating step.

The heating of the recording medium in the post-heating step can be performed using an appropriate heating unit, for example, when the ink jet recording device is used. In addition, the heating can be performed by an appropriate heating unit, not limited to the heating unit provided in the ink jet recording device. A blowing method based on blowing of air (warm air) with heating to the recording medium by a fan or the like may be used. In addition, a radiation method or a heat transfer method may be used to heat.

The surface temperature of the recording medium in the post-heating step is preferably 40 °C or higher, more preferably 50 °C or higher, still more preferably 60 °C or higher, and particularly preferably 70 °C or higher. In addition, the surface temperature of the recording medium heated in the post-heating step is preferably 100 °C or lower, more preferably 90 °C or lower, still more preferably 80 °C or lower, and particularly preferably 75 °C or lower. According to the ink jet recording method according to the present embodiment, even when the surface temperature of the recording medium is within the above-described range, the ink is sufficiently dried and a recorded material having excellent ink fixing property tends to be obtained.

### 2.4 Ink jet Recording Apparatus

As the ink jet recording device in the ink jet recording method according to the present embodiment, for example, a known ink jet printer or the like can be used. As such an ink jet printer, any of a serial type ink jet recording device adopting a serial head as a recording head or a line type ink jet recording device adopting a line head as a recording head can be used. Here, the details will be described by taking a line type ink jet recording device adopting a line head as an example.

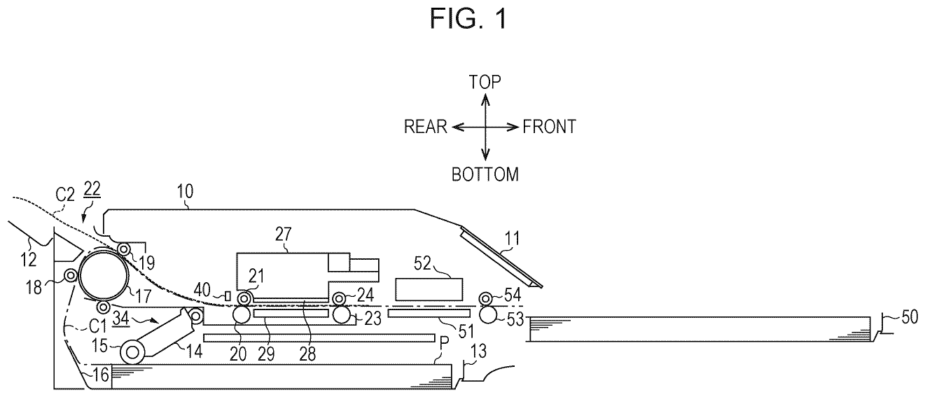

FIG. 1 shows a side cross-sectional structure of an ink jet recording device used in the present embodiment. The ink jet recording device includes a rectangular box-shaped main frame 10. Hereinafter, the right side in FIG. 1 is defined as the front side of the ink jet recording device, and the left side in FIG. 1 is defined as the rear side of the ink jet recording device.

An operation panel 11 that is a user interface is provided on a front side surface of the main frame 10. An operation switch and a liquid crystal panel is provided on the operation panel 11. In addition, a paper discharge tray 50 that is extendable and on which the printed paper P is mounted is provided at a front portion of the main frame 10. The paper discharge tray 50 can be accommodated inside the ink jet recording device when the paper P is not mounted on the paper discharge tray 50. In a case of continuously printing on a large number of sheets of recording paper P, the large number of sheets of paper P can be stacked and mounted on the paper discharge tray 50. For example, the number of sheets is 10 or more, 30 or more, 50 or more, and 70 to 500. Furthermore, an openable and closable type manual paper feed port cover 12 is provided at an upper rear portion of the main frame 10. Then, by opening the manual paper feed port cover 12, a manual paper feed port 22 for manually inserting the paper P is opened.

A paper feed tray 13 that can accommodate a large number of sheets of paper P in a stacked state is attachably and detachably provided at a lower portion of the main frame 10. In addition, a paper feeding mechanism 34 that feeds the paper P in the paper feed tray 13 is provided on an upper portion of the paper feed tray 13 in the main frame 10. The paper feeding mechanism 34 includes a swing arm 14 that is pivotally supported for swinging on the main frame 10, and a pickup roller 15 that is provided at a distal end portion of the swing arm 14. The pickup roller 15 sends the topmost sheet of the paper P stacked in the paper feed tray 13 backward in response to the rotation of the pickup roller 15. A wall surface of the paper feed tray 13 at the rear side is a separation inclined surface 16 that is inclined rearward as it is directed upward.

In the ink jet recording device, a transport path C1 of the paper P fed from the paper feed tray 13 is formed to be directed from the paper P stacked in the paper feed tray 13 toward the separation inclined surface 16, to be directed upward by the separation inclined surface 16, and to be folded forward toward the paper discharge tray 50. In addition, a transport path C2 of the paper P fed from the manual paper feed port 22 is common to the transport path C1 after the transport path C2 is merged with a portion of the transport path C1 immediately after the folding from the manual paper feed port 22. It is noted that, hereinafter, the paper feeding side in the transport paths C1 and C2 is referred to as an upstream of the transport paths C1 and C2, and the paper discharging side is referred to as a downstream of the transport paths C1 and C2.

An intermediate roller 17 as an example of the second transport roller is provided downstream of the separation inclined surface 16 in the transport path C1. A separation roller 18 that rotates in response to the rotation of the intermediate roller 17 is provided adjacent to the intermediate roller 17. An outer peripheral surface of the separation roller 18 is formed of an elastic material and is pressed against the intermediate roller 17 with a predetermined force. As a result, an appropriate rotation resistance is applied to the paper P passing between the intermediate roller 17 and the separation roller 18, whereby the paper P is prevented from being re-fed.

Furthermore, an intermediate assist roller 19 that rotates in response to the rotation of the intermediate roller 17 is provided downstream of the separation roller 18 in the transport path C1 in a state of being pressed against the intermediate roller 17.

In addition, a paper feeding roller 20 as an example of the first transport roller is provided downstream of the intermediate assist roller 19 in the transport paths C1 and C2. A paper feeding assist roller 21 that rotates in response to the rotation of the paper feeding roller 20 is pressed against the paper feeding roller 20. It is noted that a paper detection sensor that detects the presence or absence of the paper P at a position thereof is provided near the paper feeding roller 20 on the upstream of the transport paths C1 and C2. As the paper detection sensor 40, for example, an optical sensor is used.

Furthermore, paper discharge rollers 23, 53 are provided downstream of the paper feeding roller 20 in the transport paths C1 and C2. Paper discharge assist rollers 24, 54 that rotate in response to the rotation of the paper discharge roller 23 are pressed against the paper discharge roller 23.

A head unit 27 is provided inside the main frame 10. An ink jet type recording head 28 is provided below the head unit 27. The recording head 28 is a line type ink jet head including a nozzle row having a length extending over the entire width of the paper P in the width direction. The nozzle face of the line type ink jet head is provided with a nozzle row for ejecting the above-described ink jet ink composition. It is noted that, in a case of printing, the recording head 28 is positioned above a section between the paper feeding roller 20 and the paper discharge roller 23 in the transport paths C1 and C2.

A support base 29 that supports the paper P is provided at a position facing the recording head 28 inside the main frame 10. It is noted that the head unit 27 is provided to be vertically movable in the vertical direction in the drawing, and an interval between the recording head 28 and the support base 29 can be adjusted (hereinafter, referred to as gap adjustment) in response to the vertical movement of the head unit 27.

A heating device 52 is provided inside the main frame 10. The heating device 52 includes a fan that blows warm air to the paper P. The heating device 52 is positioned above a section between the paper discharge roller 23 and the paper discharge roller 53 in the transport paths C1 and C2. A paper discharge passage 51 that supports the paper P is provided at a position facing the heating device 52 inside the main frame 10. It is noted that a heat transfer type heating device may be provided in the paper discharge passage 51, or a radiation type heating device may be provided in the heating device 52.

The ink jet recording device includes a motor that is not shown in the drawings as a power source, and the paper feeding roller 20 and the paper discharge rollers 23, 53 are rotated by the motor. The rotation direction of the paper feeding roller 20 and the paper discharge rollers 23, 53 is switched in response to the rotation direction of the motor. In addition, the power of the motor 31 is also transmitted to the intermediate roller 17, and the rotation direction of the intermediate roller 17 is configured to be maintained constant.

In addition, the ink jet recording device includes a controller that is not shown in the drawings and is configured to perform various controls of the ink jet recording device. The controller is coupled to the operation panel 11, confirms an operation status of the operation switch provided on the operation panel 11, and performs display control of the liquid crystal panel provided on the operation panel 11.

### 3. Example

Hereinafter, the present disclosure will be described in more detail with reference to examples, but the present disclosure is not limited to these examples. Hereinafter, “%” is based on mass unless otherwise specified.

### 3.1 Preparation of ink jet ink Composition

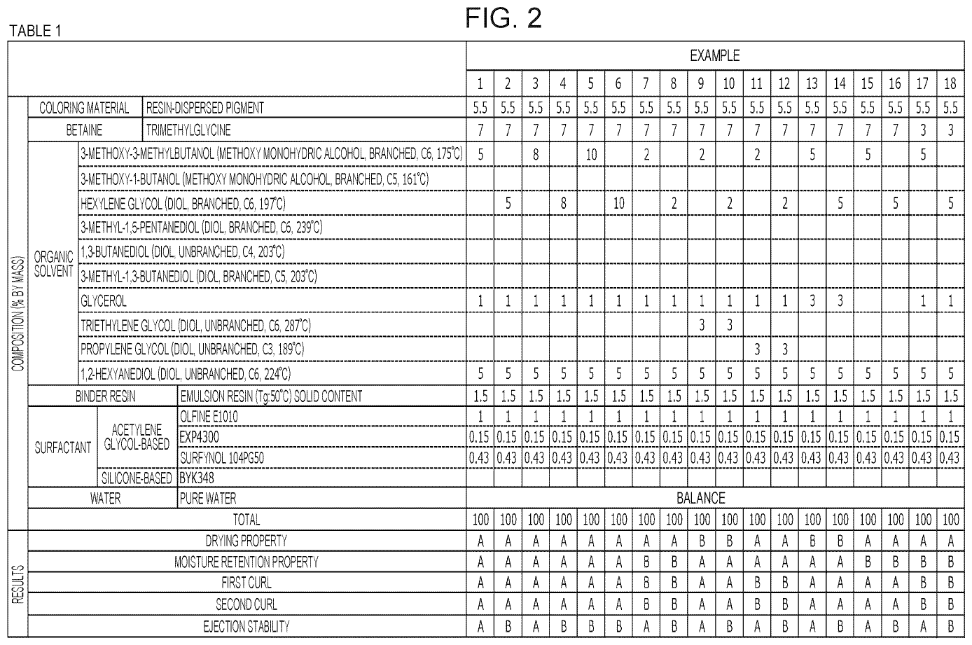

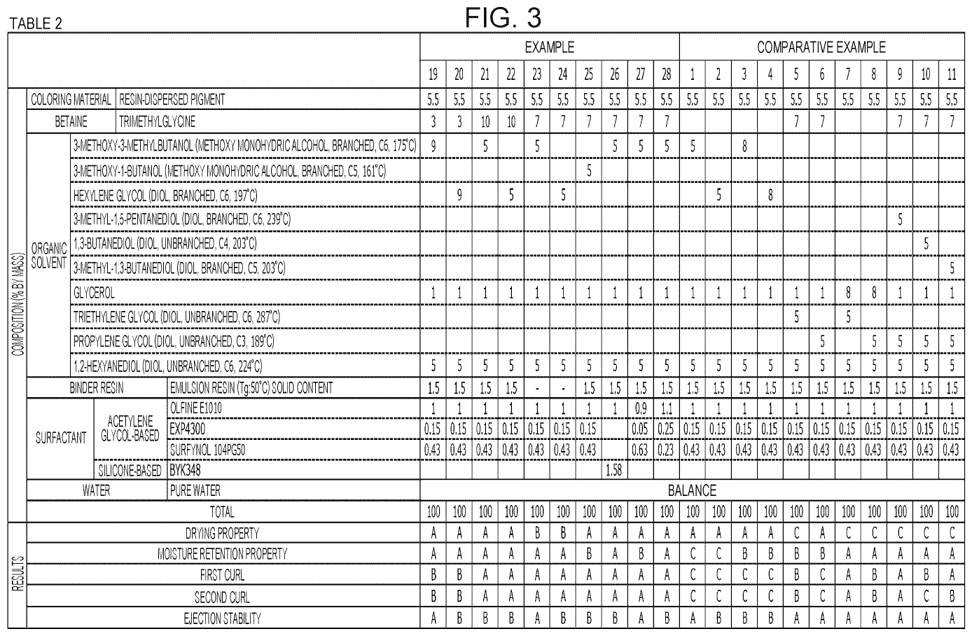

Each component is put into a container and mixed to have the composition of Table 1 (shown in FIG. 2) and Table 2 (shown in FIG. 3), and the mixture is stirred for 2 hours, and then filtered using a 5.0 μm PTFE membrane filter to obtain an ink jet ink composition according to each Example. The numerical values in the table indicate percentage (%) by mass. Water is added such that the mass of the composition is 100% by mass. For the pigment and the emulsion resin, a dispersion liquid which will be described later is prepared and used.

### Preparation of Resin-Dispersed Pigment

As a dispersant resin, an acrylic acid-acrylic acid ester copolymer (weight-average molecular weight: 25,000, acid value: 75) is prepared. 12 parts by mass of the dispersant resin is added to 155 parts by mass of ion exchange water in which 0.1 part by mass of a 30% ammonia water solution (neutralizing agent) is dissolved, and the dispersant resin is dissolved. 40 parts by mass of a pigment (C. I. Pigment Blue 15:3) is added thereto, and the mixture is dispersed for 10 hours by a ball mill using zirconia beads. After that, centrifugal filtration is performed using a centrifuge to remove impurities such as coarse particles and dust such that the concentration of the pigment is adjusted to 20% by mass to obtain a resin-dispersed pigment.

### Preparation of Emulsion Resin

The emulsion resin is obtained by emulsion-copolymerizing styrene and an acrylic monomer. As a surfactant for emulsion polymerization, Newcol NT-30 (manufactured by Nippon Nyukazai Co., Ltd.) is used, and the usage amount is 1 part by mass with the total amount of monomers as 100 parts by mass. The monomer composition is prepared such that Tg is 50 °C

### Explanations Regarding the Table will be Supplemented

### Organic Solvent

“Branched” represents that a branched carbon skeleton is present. In addition, “Unbranched” represents that a branched carbon skeleton is not present. In addition, the temperature (°C) represents the standard boiling point. In addition, the numerical value of “C” represents the number of carbon atoms in the molecule.

### Surfactant

OLFINE E1010 (manufactured by Nissin Chemical Industry Co., Ltd., product name)
EXP4300 (manufactured by Nissin Chemical Industry Co., Ltd., product name)
SURFYNOL 104PG50 (manufactured by Air Products Japan, K.K., product name)
BYK348 (manufactured by BYK Japan K.K., product name)

### 3.2. Evaluation Test

### 3.2.1 Drying Property

The ink according to each Example is filled in a modified machine of LX-10050 (line ink jet printer) manufactured by Seiko Epson Corporation, and a solid pattern is printed on coated paper (OK topcoat+, A4 size, manufactured by Oji Paper Co., Ltd.) at Duty 100% (adhesion amount: 7 mg/inch²). After the printing, the printed material is heated at 70 °C for 30 seconds. The printed material is subjected to a tape adhesion test, and the print surface is evaluated as not being peeled off according to the following criteria. It is noted that, when the drying of the ink is insufficient, the fixing property of the ink coating film deteriorate, and the ink coating film is easily peeled off. Therefore, the drying property of the ink can be evaluated by the ink fixing property of the print surface.

Evaluation criteria
A: No peeling
B: Slight partial peeling of the surface layer
C: Peeling

### 3.2.2 Moisture Retention Property

The ink according to each Example is introduced into a cartridge of a modified machine of an ink jet printer (form PX-G930, manufactured by Seiko Epson Corporation), it is confirmed that the ink is ejected from a plurality of nozzles communicating with the cartridge, and then the ink jet head is allowed to idle for a specific number of times. Thereafter, the presence or absence of nozzle dropouts during printing is conformed, and the evaluation is performed according to the following criteria.

### Evaluation Criteria

A: No nozzle dropouts after 1,000 scans
B: No nozzle dropouts after 500 scans
C: Nozzle dropouts in less than 500 scans

### 3.2.3 First Curl

The ink according to each Example is filled in a modified machine of LX-10050 (line ink jet printer) manufactured by Seiko Epson Corporation, and a solid pattern is printed on coated paper (OK topcoat+, A4 size, manufactured by Oji Paper Co., Ltd., basis weight: 104 g/m²) at a printing Duty: 100% (adhesion amount: 7 mg/inch²) at a temperature of 25 °C and a humidity of 50% in a face-up manner at 100 ppm. The angle formed between the sheet edge and the floor surface at the sheet-floor contact point is measured and, as an index of first curl, is evaluated according to the following criteria. It is noted that the first curl is a curl that occurs immediately after the ink is attached.

### Evaluation Criteria

A: Less than 45°
B: 45° or more and less than 90°
C: 90°or more

### 3.2.4 Second Curl

The ink according to each Example is filled in a modified machine of LX-10050 (line ink jet printer) manufactured by Seiko Epson Corporation, and a solid pattern is printed on coated paper (OK topcoat+, A4 size, manufactured by Oji Paper Co., Ltd., basis weight: 104 g/m²) at a printing Duty: 100% (adhesion amount: 7 mg/inch²) at a temperature of 25 °C and a humidity of 50%. Then, the amount of the paper end lifted from the floor surface in a case of being heated at 70 °C for 30 seconds after the printing is measured, and the evaluation is performed according to the following criteria.

### Evaluation Criteria

A: Less than 10 mm
B: 10 mm or more and less than 20 mm
C: 20 mm or more

### 3.2.5 Ejection Stability

The ink according to each Example is introduced into a cartridge of a modified machine of an ink jet printer (form LX-10050, manufactured by Seiko Epson Corporation), it is confirmed that the ink is ejected from a plurality of nozzles communicating with the cartridge, a test pattern is printed on 30 A4 -sized paper sheets continuously, and after the 30 sheets are printed and stacked on the paper discharge tray, the nozzle check is performed to evaluate the ejection characteristics according to the following criteria. It is noted that a landing position deviation of half or more of the nozzle-to-nozzle distance is referred to as a wobble.

### Evaluation Criteria

A: No unstable ejection from nozzle
B: Nozzle dropouts, 5 or less streaks, recovered with one cleaning

C: Nozzle dropouts, 5 or more streaks, not recovered with one cleaning

### 3.3 Evaluation Results

The evaluation results are shown in Tables 1 and 2. From the evaluation results described in Tables 1 and 2, an ink jet ink composition according to an embodiment of the present disclosure is an aqueous ink jet ink composition, the ink jet ink composition containing betaine and an organic solvent, in which the organic solvent includes an organic solvent A having a standard boiling point of 150 °C to 200 °C, having 4 to 7 carbon atoms, and having a branched carbon skeleton, which is a diol or a monohydric alcohol having one methoxy group, in which both excellent drying property of the ink and suppression of the second curl can be achieved. Furthermore, the moisture retention property, the first curl suppression, and the ejection stability tend to be excellent. It is noted that, in Example 27, the coating paper was sufficiently coated with the ink in the solid pattern in which the ink was attached to the coating paper, and the color-developing property was more excellent than those in Example 1.

On the other hand, the ink jet ink composition according to each of the comparative examples that does not satisfy the above-described configuration has a defect in at least one of the drying property of the ink or the second curl.

The following contents are derived from the above-described embodiments.

An aspect of the ink jet ink composition is an aqueous ink jet ink composition containing betaine and an organic solvent, in which the organic solvent includes an organic solvent A having a standard boiling point of 150 °C to 200 °C, having 4 to 7 carbon atoms, and having a branched carbon skeleton, which is a diol or a monohydric alcohol having one methoxy group.

In an aspect of the ink jet ink composition, the content of the betaine may be 0.5% to 10% by mass with respect to the total amount of the ink jet ink composition.

In any aspect of the ink jet ink composition, the content of the organic solvent A may be 1% to 15% by mass with respect to the total amount of the ink jet ink composition.

In any aspect of the ink jet ink composition, the organic solvent further includes an organic solvent having a standard boiling point of 240 °C or higher, which is polyhydric alcohols or glycol ethers, and the content of the organic solvent having a standard boiling point of 240 °C or higher, which is polyhydric alcohols or glycol ethers, may be 4% by mass or less with respect to a total amount of the ink jet ink composition.

In any aspect of the ink jet ink composition, an acetylene glycol-based surfactant may be contained.

In any aspect of the ink jet ink composition, a binder resin may be contained.

In any aspect of the ink jet ink composition, a coloring material may be contained.

In any aspect of the ink jet ink composition, the organic solvent may not include more than 4% by mass of an organic solvent having a standard boiling point of 200 °C or lower and not having a branched carbon skeleton, which is polyhydric alcohols or glycol ethers, with respect to a total amount of the ink jet ink composition.

In any aspect of the ink jet ink composition, the organic solvent further may include an organic solvent having a standard boiling point of higher than 200 °C and lower than 240 °C, which is polyhydric alcohols or glycol ethers.

In any aspect of the ink jet ink composition, the ink jet ink composition may be used for recording on a low-absorbency recording medium having paper as a substrate.

In the aspect of the ink jet ink composition, the low-absorbency recording medium having paper as a substrate may be cut-sheet paper.

According to an aspect of the present disclosure, an ink jet recording method includes an attaching step of ejecting the ink jet ink composition according to any one of the above-described aspects from an ink jet head to attach the ink jet ink composition to a recording medium.

The present disclosure is not limited to the above-mentioned embodiment, and various modifications are possible. For example, the present disclosure includes a configuration substantially the same as the configuration described in the embodiment, for example, a configuration having the same function, method, and result, or a configuration having the same object and effect. In addition, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. In addition, the present disclosure includes configurations in which a known technology is added to the configurations described in the embodiments.

What is claimed is:

1. An aqueous ink jet ink composition comprising:
betaine; and
an organic solvent, wherein
the organic solvent includes an organic solvent A having a standard boiling point of 150 °C to 200 °C, having 4 to 7 carbon atoms, and having a branched carbon skeleton, which is a diol or a monohydric alcohol having one methoxy group.

2. The ink jet ink composition according to claim 1, wherein
a content of the betaine is 0.5% to 10% by mass with respect to a total amount of the ink jet ink composition.

3. The ink jet ink composition according to claim 1, wherein
a content of the organic solvent A is 1% to 15% by mass with respect to a total amount of the ink jet ink composition.

4. The ink jet ink composition according to claim 1, wherein
the organic solvent further includes an organic solvent having a standard boiling point of 240 °C or higher, which is polyhydric alcohols or glycol ethers, and
a content of the organic solvent having a standard boiling point of 240 °C or higher, which is polyhydric alcohols or glycol ethers, is 4% by mass or less with respect to a total amount of the ink jet ink composition.

5. The ink jet ink composition according to claim 1, further comprising:
an acetylene glycol-based surfactant.

6. The ink jet ink composition according to claim 1, further comprising:
a binder resin.

7. The ink jet ink composition according to claim 1, further comprising:
a coloring material.

8. The ink jet ink composition according to claim 1, wherein
the organic solvent does not include more than 4% by mass of an organic solvent having a standard boiling point of 200 °C or lower and not having a branched carbon skeleton, which is polyhydric alcohols or glycol ethers, with respect to a total amount of the ink jet ink composition.

9. The ink jet ink composition according to claim 1, wherein
the organic solvent further includes an organic solvent having a standard boiling point of higher than 200 °C and lower than 240 °C, which is polyhydric alcohols or glycol ethers.

10. The ink jet ink composition according to claim 1, wherein
the ink jet ink composition is used for recording on a low-absorbency recording medium having paper as a substrate.

11. The ink jet ink composition according to claim 10, wherein
the low-absorbency recording medium having paper as a substrate is cut-sheet paper.

12. An ink jet recording method comprising:
an attaching step of ejecting the ink jet ink composition according to claim 1 from an ink jet head to attach the ink jet ink composition to a recording medium.
